(19) United States
(12) Patent Application Publication
(10) Pub. No.: US 2010/0207060 A1
(43) Pub. Date: Aug. 19, 2010

(54) COMBINATION OF ADDITIVES FOR USE IN PREPARATION OF THERMOPLASTICS

(75) Inventors: Ferdinand Mannle, Oslo (NO); Kaare Roger Rodseth, Gursken (NO); Emil Arne Kleppe, Gursken (NO); Roger Hauge, Gursken (NO); Bjorn Steinar Tanem, Trondheim (NO)

Correspondence Address: DENNISON, SCHULTZ & MACDONALD, 1727 KING STREET, SUITE 105, ALEXANDRIA, VA, 22314, US

(73) Assignee: NOR-X INDUSTRY AS, Gursken (NO)

(21) Appl. No.: 12/297,805

(22) PCT Filed: Apr. 23, 2007
(86) PCT No.: PCT/NO2007/000137

§ 371 Date: Feb. 12, 2009

(30) Foreign Application Priority Data
Apr. 21, 2006 (NO) 20061768

(51) Int. Cl. C09K 3/00; C08L 79/02

(52) U.S. Cl. 252/182.12; 523/124

(57) ABSTRACT

Combination of additives suitable for use in production or preparation of thermoplastics comprising at least one metal comprising compound i) and at least one compound ii) chosen among not sterically hindered, aliphatic amines, oligoamines or polyamines, or a precursor for not sterically hindered, aliphatic amines, oligoamines or polyamines, alternatively also a compound which wholly or partially can be manufactured by condensation of one or more alcohols and/or compounds which can be manufactured by ring-opening addition of epoxide type compounds. Furthermore the invention concerns a method for changing properties of thermoplastics using such a combination as well as the resulting thermoplastics and products based on such thermoplastics.

According to a first aspect the present invention concerns combinations of additives to thermoplastic materials suitable for production of degradable thermoplastics. According to a second aspect the present invention concerns a method for changing the properties of thermoplastic materials by adding a suitable combination of additives to thermoplastic materials. Furthermore the present invention concerns, according to a third aspect, thermoplastic materials produced by the method according to the second aspect of the invention. Finally the invention concerns products of thermoplastic materials produced according to the second aspect of the invention.

### BACKGROUND

A strategy for production of thermoplastic materials with significantly increased degradability is to add prodegradants to commercial thermoplastics. By thermoplastics are included thermoplastic polymers and polymer materials as described by “Macromolecules”, Elias, Hans-Georg, 1. ed. (2006), Wiley-VCH, Weinheim. Examples are polyethylene (PE), polypropylene (PP), polyethylene terephtalate (PET) or polystyrene. The additives are usually added to the commercial thermoplastics in the form of concentrated formulations of one or more additives in a suitable matrix material. Such concentrated formulations are called master batches.

Master batches with one or more additives which under influence of light and/or heat catalyze their oxidative degradation are typically added to commercial thermoplastics. Such oxidation promoting additives are denoted prodegradants. Contrary to master batches with hydrolysable materials like starch and modified starch or aliphatic polyesters (Angew. Chem., Int. Ed 2004, 43, 1078-1085) such additives usually are easily dissolved in commercial thermoplastics. Thus, the modified thermoplastics exhibit properties similar to the properties of the unmodified thermoplastics. A challenge with this method is to find a system of additives that is compatible with the preparation processes of the thermoplastic material (film blowing, extrusion, injection moulding, blow moulding). A possible degradation during the preparation process should be prevented or restricted so that the fresh product exhibits the desired material properties. Another challenge is that the oxidative degradation process occurs much more quickly when light (particularly with UV contribution) is present compared to the degradation under dark conditions. Thus the additive or the additive combination should be chosen in a manner so that the product maintains its properties within a desired storage and/or use period while degradation occurs quickly after such elapsed time period.

Known additives leading to accelerated degradation of thermoplastics are metal salts or complex metal compounds in which the metal is able to reversibly change its oxidation state (I. I. Eyenga et. al., Macromol. Syrup., 178, 139-152 (2002)). Most used are fat soluble compounds of transition metals like cobalt, cerium or iron (US 20010003797; U.S. Pat. No. 5,384,183; U.S. Pat. No. 5,854,304; U.S. Pat. No. 5,565,503; DE 2244801 B2; U.S. Pat. No. 5,212,219) or formulations of transition metal salts with different types of waxes (U.S. Pat. No. 5,155,155). Examples of degradation-controllable thermoplastics comprising a combination of hydrolysable material and metal salts or complex metal compounds are described in U.S. Pat. No. 5,135,966. In addition to metal salts or complex metal compounds so-called photo initiators, i.e. materials that under influence of light form radicals, may also be included (U.S. Pat. No. 4,517,318; U.S. Pat. No. 4,038,227; U.S. Pat. No. 3,941,759).

Cho, Youngmin, Park, Hyunwoong, and Choi, Wonyong, Journal of Photochemistry and Photobiology, A: Chemistry (2004), 165(1-3), 43-50, describe a light induced dehalogenation of tetrachloromethane by means of a ferric (III) compound and polyoxyethylene stearylethers.

U.S. Pat. No. 4,224,416 teaches a degradable polymer composition comprising an organic amine as an autoxidizable organic compound. The polymer composition is presented as an alternative to degradable polymers based on fat soluble compounds of transition metals such as stearates of cobalt, cerium or iron, since the preparation of the polymer composition is easier to control than when transition metals are used.

Aromatic amines and sterically hindered amines are commonly used as antioxidants and long term stabilizers in thermoplastics. A comprehensive overview of examples of such compounds are provided on p 123-136 and on p. 107-108 in “Plastics Additives Handbook”, Zweifel, Hans (ed), 5. ed (2001) Carl Hanser Verlag, München. Their use are disclosed on the pages 40-419 in the same book.

Synthesis of stearates such as iron (ferric) stearate is described in periodicals (H. B. Abrahamson, H. C. Lukaski, Journal of Inorganic Biochemistry, 54, 115-130 (1994)) and patent publications (U.S. Pat. No. 5,434,277).

A particular method for the preparation of a certain type of iron stearate based on ferric chloride and stearic acid is described in WO 2004/094516. Degradable thermoplastics based on this type of ferric stearate exhibit good processing (preparation) properties and good degradability.

Utilization of iron stearate rather than other transition metal compounds in degradation-controllable thermoplastics does not lead to spill of compounds that can be harmful to the environment. With respect to approval of degradation-controllable thermoplastics for indirect contact with food articles, the restrictions for iron compounds are less demanding than for other transition metal compounds.

A challenge of the manufacture of products based on degradable thermoplastic materials is that the processing takes place at a high temperature, typically between 180 and 300° C. Typical manufacture processes involves film blowing, blow moulding, thermoforming, rotational moulding, or injection moulding. It will be an object to provide a sufficiently high number of stable radicals as soon as the thermoplastic material is heated. Such stable radicals will inhibit oxidative degradation during processing of the thermoplastic material even in combination with prodegradants. Stabilizers inhibiting oxidative degradation during preparation of thermoplastic are called process stabilizers. Stabilizers inhibiting oxidative degradation during storage or use of thermoplastics or products thereof are called long term stabilizers.

Table 1 illustrates the typical suitability of different types of stabilizers as process stabilizers and long term stabilizers.

TABLE 1

| | Suitable as long term | Suitable as process |
|---|---|---|
| Stabilizer type | stabilizer | stabilizer |
| hindered phenol | Yes | Yes |
| hindered amines | Yes | No |
| Organic phosphite | No | Yes |
| Hydroxyl amine | No | Yes |
| Lactone | No | Yes |
| alfa-tocoferol | No | Yes |

The most significant difference between a process stabilizer and a long term stabilizer is described below.

A suitable process stabiliser rapidly forms stable radicals when a thermoplastic resin is heated and melted. The radical concentration formed by a suitable process stabilizer is large enough and stable enough to prevent the thermoplastic resin to degrade for the period of the preparation process. A mere process stabilizer is consumed or inactive, ie. no longer radical forming after the prepared thermoplastic has been cooled, typically to ambient temperature Typical stabilizers which are suitable only as process stabilizers are organic phosphites, hydroxylamines, lactones and alfa-tocoferol.

Contrary to a process stabilizer, a suitable long term stabilizer forms radicals when the preparation process is completed and the prepared thermoplastic has been cooled, typical to ambient temperature. A mere long term stabilizer does not form radicals quickly enough during the preparation process to prevent degradation of the thermoplastic at this stage. Typical stabilizers which are suitable as log time stabilizers are hindered amines.

Hindered amines can be suitable as both process stabilizers and long term stabilizers because hindered phenols form stable radicals both during the preparation process and after the prepared thermoplastic has been cooled, typically to ambient temperature. In case a hindered phenol is only used as a process stabilizer, all of it must be consumed or degraded to non radical-forming products when the prepared thermoplastic has been cooled.

Process stabilizers, long term stabilizers, pigments, dyes, slip agents, nucleation agents, and fillers are additives to polymer materials (resins). An extensive selection of such additives is provided in “Plastics Additives Handbook”, Zweifel, Hans (ed.), 5. edition (2001), Carl Hanser Verlag, München. Examples are:

| | CAS number |
|---|---|
| Phosphites: | |
| tetrakis(2,4-di-tert-butylphenyl)[1,1- | [119345-01-6] |
| biphenyl]-4,4′-diylbisphosphonite | |
| tris(2,4-ditert-butylphenyl)phosphite | [31570-04-4] |
| Phosphoric acid monoethyl-bis[2,4-bis(1,1- | [145650-60-8] |
| dimethyletyl)-6-methylphenyl-ester | |
| Thiosynergists: | |
| dodecyl-3,3′-dithio propionate | [123-28-4] |
| Hindrede fenoler: | |
| tetrakis(3-(3,5-di-tert-butyl-4- | [6683-19-8] |
| hydroxyphenyl)propionylpentaerytrit | |
| 1,3,5-tris-(3,5-di-tert-butyl-4- | [1709-70-2] |
| hydroxyphenyl)methyl-2,4,6-trimethyl | |
| benzene | |
| 6,6′-di-tert-butyl-2,2′-thiodi-p-cresole | [90-66-4] |
| Hydroquinone compounds: | |
| 2,5-di-tert-butyl hydroquinone | [88-558-4] |
| C—H acidic radical scavengers: | |
| 3-xylyl-5,7-di-tert-butyl-benzofuranone | [181314-48-7] |
| Hydroxylamines: | |
| Distearyl hydroxylamine | [143925-92-2] |
| Hindered amines: | |
| N,N′″-[1,2-ethane-diyl-bis[[[4,6-bis-[butyl | [106990-43-6] |
| (1,2,2,6,6-pentamethyl- | |
| 4-piperidinyl)amino]-1,3,5-triazin-2-yl] | |
| imino]-3,1-propane diyl]]- | |
| bis[N′,N″-dibutyl-N′,N″-bis(1,2,2,6,6- | |
| pentamethyl-4-piperidinyl)- | |
| 2,4,6-triamino-1,3,5-triazine | |
| Bis(2,2,6,6,-tetramethyl-4- | [52829-07-9] |
| piperidyl)sebaceate | |
| UV absorbers: | |
| 2-hydroxy-4-(octyloxy)-benzophenone | [1843-05-6] |
| 2-benzotriazol-2-yl-4,6-di-tert-butylphenole | [3846-71-7] |
| Dyes: | |
| rhodamine B base | [509-34-2] |
| Pigments: | |
| pigment red 3 | [2425-85-6] |

Controlled degradation of thermoplastics can principally be used to make materials with low oxygen permeability. A number of publications and patent applications have been published on so-called oxygen scavengers. The principle is the same in all these cases, an additive ensures that oxygen is chemically bound in the barrier material when the barrier material is oxidatively degraded. Below an overview of some such publications are listed.
Oxygen scavenging film with antifog properties. Schwark, Dwight W.; Speer, Drew. (Cryovac, Inc., USA). U.S. Pat. Appl. Publ. (2004), 16 pp.
Manufacture of oxygen-barrier saponified EVA compositions with controlled water content and good extrudability. Inoue, Kaoru; Moriyama, Takao. (Nippon Synthetic Chemical Industry Co., Ltd., Japan). Jpn. Kokai Tokkyo Koho (2004), 14 pp.
Long-term storage of oxygen-scavenging polyamide moldings. Otaki, Ryoji. (Mitsubishi Gas Chemical Co., Ltd., Japan). Jpn. Kokai Tokkyo Koho (2003), 8 pp.
Multilayered structures with good oxygen scavenge and appearance. Maruyama, Katsuya; Takahashi, Makoto; Hiramatsu, Sotaro. (Mitsubishi Gas Chemical Co., Ltd., Japan). Jpn. Kokai Tokkyo Koho (2003), 9 pp.
Oxygen-scavenging packaging. Jerdee, Gary D.; Leonard, James P.; Ching, Ta Yen; Goodrich, Joseph L.; Rodgers, Brad D.; Schmidt, Richard P. (Chevron Chemical Company LLC, USA). U.S. (2003), 16 pp.,
Cost-effective oxygen-scavenging and gas-barrier thermoplastic multilayer films. Takashima, Masahiko; Kashiba, Takashi; Ito, Yoshiki; Okada, Satoshi; Wada, Tomotaka; Kutsuna, Takaaki. (Mitsubishi Gas Chemical Co., Ltd., Japan). Jpn. Kokai Tokkyo Koho (2003), 10 pp.
Laminated multilayer packaging material with gas barrier properties and its preparation methods. Share, Paul E.; Pillage, Keith R. (USA). U.S. Pat. Appl. Publ. (2003), 11 pp.,
Multilayer structure coatings with low permeation of gases and vapors. Czeremuszkin, Grzegorz; Latreche, Mohamed; Wertheimer, Michael Robert. (Polyvalor, Societe en Commandite, Can.). PCT Int. Appl. (2003), 47 pp.
Oxygen- and water vapor-barrier pinhole-resistant outer packages of oxygen scavengers. Kubota, Chiharu; Otsuka, Masayuki. (Mitsubishi Gas Chemical Co., Ltd., Japan). Jpn. Kokai Tokkyo Koho (2002),
Production of ethylene-vinyl alcohol copolymer-based oxygen barrier films containing oxidizable polydiene.
Tsai, Mingliang L.; Akkapeddi, Murali K. (Honeywell International Inc., USA). PCT Int. Appl. (2002), 41 pp.
Odorless oxygen-barrier multilayer polymer structures, multilayer containers, and caps with gaskets comprising the structures. Nakaya, Masakazu; Tai, Shinji; Shimo, Hiroyuki. (Kuraray Co., Ltd., Japan). Jpn. Kokai Tokkyo Koho (2002), 23 pp.
Oxygen scavenging film based on enzyme catalytic active material as adhesive. Lehtonen, Paavo. Bioka Ltd., Kantvik, Finland. European Polymers, Films, Laminations and Extrusion Coatings Conference, 8th, Barcelona, Spain, May 28-30, 2001 (2001), 75-81.

### Objectives

It is thus an object of the present invention to provide means that allow manufacture of thermoplastics with good oxygen barrier properties.

Another object is to provide means for addition to raw material for thermoplastics which allows production and subsequent preparation of the produced thermoplastic at higher temperatures, such as temperatures in the range up to at least 300° C.

A further object of the present invention is to provide a method for the manufacture of thermoplastics which allows preparation by conventional means to products with improved barrier properties, especially oxygen barrier properties.

Yet another object of the present invention is to provide means allowing manufacture of thermoplastics with good thermal degradability.

### The Invention

The mentioned objects are achieved by the present invention which according to a first aspect comprises a combination of additives suitable for use in manufacturing or preparing thermoplastics. The combination comprises at least i) one metal comprising compound and at least ii) one compound chosen among not sterically hindered, aliphatic amines, oligoamines or polyamines, or a precursor for not sterically hindered, aliphatic amines, oligoamines or polyamines.

The metal in its pure form or in a metal compound can be practically any metal, such as Sc, Ti, V, Cr, Mn, Fe, Co, Ni, Cu, Ga, Ge, As, Y, Zr, Nb, Mo, Ru, Rh, Pd, Ag, Cd, Hg, Sn, Sb, La, Ce, Pr, Nd, Sm, Eu, Gd, Tb, Dy, Ho, Er, Tm, Yb, Lu, Hf, Ta, W, Re, Os, Ir, Pt, Au, Pb og Bi. T is convenient that the metal is chosen from a group of low toxicity and which is readily available at a fair price.

It is preferred that the metal is chosen from the group consisting of Sc, Ti, V, Cr, Mn, Fe, Co, Ni, Cu, Ce and more preferred from the group consisting of Mn, Fe, Co, Cu, Ce, V. It is furthermore convenient and therefore preferred that the metal compound is fat soluble.

In some applications it is preferred that the metal is present as a salt or as a metal complex.

The metal compound can be added to the thermoplastic during production and/or preparation process, the metal compound being in the form of compounds like catalyst remains, abrasion “products” (dust) from preparation equipment as well as contaminations.

Compound ii) can wholly or partially be described as:

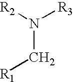

where the group R₁, R₂, R₃ are chosen among hydrogen, hydroxyl, non substituted saturated or unsaturated C₁-C₂₄ alkyl, substituted saturated or unsaturated C₁-C₂₄ alkyl, substituted or non substituted aryl, aliphatic or aromatic carbonyl, the chains of said compounds optionally containing one or more of the elements oxygen, nitrogen, sulphur, phosphorous, silicon, and boron; or groups chosen among condensation products or addition products of one or more typical chemical compounds such as acids, alcohols, phenols, amines, aldehydes, or epoxides.

The amine which wholly or partially constitute compound ii) can according to a preferred embodiment be described as:

X—(O—CR₁R₂—CR₃R₄—O)ₚ—(CR₁R₂—CR₃R₄—O—CR₅R₆—CR₇R₈—O)_{q}—(CR₅R₆—CR₇R₈—O)ᵣ—Y

where the group R₁-R₈ are chosen among hydrogen, hydroxyl, non substituted saturated or unsaturated C₁-C₂₄ alkyl, substituted saturated or unsaturated C₁-C₂₄ alkyl, substituted or non substituted aryl, aliphatic or aromatic carbonyl, the chains of said compounds optionally containing one or more of the elements oxygen, nitrogen, sulphur; phosphorous, silicon, and boron while at least one of X, Y are chosen among amino, alkylamino, dialkylamino while the other of X, Y is chosen among hydrogen, hydroxyl, amino, alkylamino, dialkylamino, while p, q, r being integers from 0 to about 1000, provided that at least one of p, q, r is larger than 0.

The amine can wholly or partially be present as a salt or wholly or partially as a metal-amine complex. Examples are aromatic and aliphatic amines which are complex bound to Cu or Ni salts.

Compound ii) of the combination according to the present invention can furthermore be present in the form of a precursor for an amine, oligoamine or polyamine so that amine, oligoamine or polyamine is formed in situ when or after being combined with compound i) and/or compound ii) or alternatively during the production of the thermoplastic (resin).

The amount ratios between compound i) and compound ii) can vary within broad limits, but is generally such that on a weight basis the ratio between the metal in compound i) and the entire compound ii) the ratio is in the range from 1:30 to 1:3.

It is particularly preferred that the combination according to the present invention further includes a compound iii) chosen among compounds which wholly or partially can be manufactured by condensation of one or more alcohols and compounds which can be manufactured by ring-opening addition of heterocyclic organic compounds comprising at least one oxygen atom.

Compound iii) of the combination according to the present invention can be a condensation product of mono or poly functional alcohols. Compound iii) can further more comprise at least one heterocyclic, oxygen containing aliphatic structure element (even subsequent to a ring opening reaction). The heterocyclic, organic compound comprising at least one oxygen atom can in some embodiments be an epoxide derivative. In other embodiments the heterocyclic organic compound comprising at least one oxygen atom can be an oxetane derivative or a furane derivative.

The term “monofunctional alcohols” refers to alcohols with just one OH group per alcohol molecule. Examples are methanol, ethanol and stearyl alcohol.

The term “polyfunctional alcohol” refers to alcohols with more than one OH group per alcohol molecule, examples of which are glycol, propylene glycol, glycerol and sorbitol.

Compound iii) can in a preferred embodiment be represented by the formula:

X—(O—CR₁R₂—CR₃R₄—O)ₖ—(CR₁R₂—CR₃R₄—O—CR₅R₆—CR₇R₈—O)ᵣ (CR₅R₆—CR₇R₈—O)ₘ—Y

where the groups R₁-R₈ are chosen among hydrogen, hydroxyl, non substituted saturated or unsaturated C₁-C₂₄ alkyl, substituted saturated or unsaturated C₁-C₂₄ alkyl, substituted or non substituted aryl, aliphatic or aromatic carbonyl, the carbon chains of said compounds comprising one or more of the elements oxygen, nitrogen, sulphur, phosphorus, silicon, and boron and X, Y being chosen among hydrogen, acyl, non substituted saturated or unsaturated C₁-C₂₄ alkyl, substituted saturated or unsaturated C₁-C₂₄ alkyl, substituted or non substituted aryl, aliphatic or aromatic carbonyl, the carbon chains of said compounds optionally containing one or more of the elements oxygen, nitrogen, sulphur, phosphorous, silicon, and boron, k, l and m being integers from 0 to about 1000, provided that at least one of k, l, in is larger than 0.

An alcohol component of compound ii) can be described as:

X—(CR₁R₂—)ₙ(CR₃R₄—)ₒOH

where the groups R₁-R₄ are chosen among hydrogen, hydroxyl, non substituted saturated or unsaturated C₁-C₂₄ alkyl, substituted saturated or unsaturated C₁-C₂₄ alkyl, substituted or non substituted aryl, aliphatic or aromatic carbonyl, the carbon chains of said compounds optionally containing one or more of the elements oxygen, nitrogen, sulphur, phosphorous, silicon, and boron, X being chosen among hydrogen, hydroxyl, acyl, non substituted saturated or unsaturated C₁-C₂₄ alkyl, substituted saturated or unsaturated C₁-C₂₄ alkyl, substituted or non substituted aryl, aliphatic or aromatic carbonyl, the carbon chains of said compounds optionally containing one or more of the elements oxygen, nitrogen, sulphur, phosphorous, silicon, and boron n, o being integers from 0 to about 30, provided that at least one of n, o is different from 0.

In some embodiment it is preferred that at least one alcohol component of compound iii) is a mono functional alcohol, while in some embodiments it is preferred that at least one alcohol component of compound iii) is a polyfunctional alcohol.

The combination of additives to thermoplastics according to the present invention can preferably be present in a concentrated form, as a masterbatch. In cases where the combination comprises at least three components the masterbatch can comprise all components or at least two components while, in the latter case, at least one component is added shortly before use.

The master batch can be present as a solution or as a dry mixture and can include further process stabilizers and/or long term stabilizers. The masterbatch can also be present as a dry mixture of masterbatches based on additives according to the invention. Such dry mixtures of masterbatches can also comprise masterbatches based of process stabilizers and/or long term stabilizers as well as one or more compounds chosen among pigments, dyes, slip agents, nucleation agents and/or fillers.

A dry mixture in the form of a combination of masterbatches can e.g. comprise up to 30% y weight of a stabilizer masterbatch. The stabilizer masterbatch can comprise at least one component chosen among phosphite phenol, lactone, hydroxylamine and alfa-tocoferol.

The combination according to the first aspect of the present invention can furthermore include a thermoplastic in an amount of 50% by weight, ore preferred at least 95% by weight and in some cases at least 99% y weight, chosen among polyethylene LD, polyethylene HD, polyethylene LLD, polypropylene homopolymer, polypropylene random copolymer, polypropylene block copolymer, polybutylene, EVOH, polyamide, polyvinyl alcohol, polyester, polyurethane and polystyrene as well as any combination of two or more thereof.

Furthermore the combination according to the invention which includes a thermoplastic in an amount of at least 95% by weight based on the combination, can comprise at least two thermoplastic materials constituting a laminate of at least two layers where the metal comprising compound i) and the second compound ii) independent of each other can be present in one two or more layers.

When a nucleation agent is present in the combination according to the present invention, it can be manufactured wholly or partially by use of sorbitol or wholly or partially by use of a compound chosen among benzaldehyde, aceto-phenon and benzoic acid.

The combination of additives implies that the additives are present in a mixture with each other already before their intended use as additive for a thermoplastic, but need not do so. The additives can be added separately, alternatively to different layers of a product, again alternatively surrounded by other compounds in a manner ensuring slow release of the additive in question to the thermoplastic.

According to another aspect the present invention as mentioned concerns a method for changing the properties of thermoplastics by adding at any stage of the their production or preparation at least one metal comprising compound i) and at least one compound ii) which are chosen among not sterically hindered, aliphatic amines, oligoamines or polyamines, or a precursor for a not sterically hindered, aliphatic amines, oligoamines or polyamines.

The skilled artisan will understand that the features described as preferred in relation to the first aspect t of the invention also is preferred in relation to this second aspect of the invention.

The properties of the thermoplastics may this way be changed as shown below with respect to their degradability as well as their barrier properties, particularly their oxygen barrier properties, which, according to the method constituting an aspect of the invention, may be significantly improved.

Products made by thermoplastics having good oxygen barrier properties are often laminate based. Such laminates are usually poorly miscible with the pure thermoplastic components constituting the layers of such laminates. As shown by the examples below the combination of additives according to the present invention, can improve the miscibility of a laminate in the thermoplastic components of said laminate.

According to another and third aspect the present invention concerns thermoplastics comprising at least one metal comprising compound i) and at least one compound ii) chosen among not sterically hindered, aliphatic amine, oligoamine or polyamine, or a precursor for a not sterically hindered, aliphatic amine, oligoamine or polyamine.

Such thermoplastic can, as a person skilled in the art will recognize from the discussion of the first aspect of the invention, furthermore include component iii) chosen among compounds which wholly or partially can be manufactured by condensation of one or more alcohols and compounds which can be manufactured by ring-opening addition of heterocyclic organic compounds comprising at least one oxygen atom.

Such a thermoplastic exhibits, with or without compound iii), an oxygen permeability that is lower than the oxygen permeability of a corresponding thermoplastic which does not include the combination of compound i) and compound ii). Typically the oxygen permeability is reduced with at least 50% compared to a corresponding thermoplastic which does not include the combination of compound i) and compound ii).

The thermoplastic according to the third aspect of the present invention can comprise at least two thermoplastics in an amount of at least 95% by weight in which the thermoplastics constitute a laminate of at least two layers where compound i) and compound ii) independently can be present in one or more layers.

Furthermore the present invention concerns products constituting or comprising the above mentioned thermoplastics, which by means of film blowing or foil extrusion is shaped to film or foil end or intermediate products, hereunder bis-oriented film. Such products include e.g. plastic bags, sunlight collector foils, other types of foils for use in agriculture, foodstuff packaging, other packaging, and other types of bags and sacks.

Still further the invention concerns products constituting or comprising the above mentioned thermoplastics, which by means of injection moulding is shaped to injection moulded end or intermediate products. Such product include e.g. foodstuff packaging other packaging, disposable articles for household or industry or for use with foodstuff and/or beverage.

Still further the present invention concerns products constituting or comprising the above mentioned thermoplastics, which by means of thermoforming are shaped to thermoformed end or intermediate products. Such products include e.g. foodstuff packaging, other packaging, disposable articles for household or industry, or for use with foodstuff and/or beverage.

Still further the present invention concerns products constituting or comprising the above mentioned thermoplastics, which by means of extrusion are shaped to extruded end or intermediate products. Such products include e.g. products for industrial purposes, constructional purposes, hereunder transportation and building constructions, fibre shaped products, band shaped products, hereunder woven and non-woven products.

Still further the present invention concerns products constituting or comprising the above mentioned thermoplastics, which by means of blow moulding are shaped to blow moulded end or intermediate products. Such products include e.g. foodstuff packaging, other packaging, disposable articles for household or industry, or for use with foodstuff and/or beverage.

Finally the present invention concerns products constituting or comprising the above mentioned thermoplastics, which by means of co-extrusion of at least two layers are shaped to a laminated end or intermediate product. Such products include e.g. barrier films or barrier receptacles for nutrients or chemicals which are sensitive to air.

The above mentioned products of the present invention can have the form of an autonomous, homogenous product, i.e all components are evenly dispersed in a polymer matrix. The products can furthermore comprise plural layers in a laminate of which at least one layer is constituted by a thermoplastic according to the present invention while other layers can have a composition which falls within or outside the definition of the present invention. In cases where the other layers fall outside the definition of the present invention, these layers can be single component or plural component polymers, typically polyolefins, or substrates of other, non polymer type. The products can have shape of tubes or receptacles embracing or surrounding other types of products, such as foodstuff or beverage or other types of goods.

A thermoplastic material according to the present invention can be used as a barrier layer between layers of polyolefins, typically in products constituting foodstuff packaging. Thermoplastics according to the invention and comprising a combination of additives according to the first aspect of the present invention, exhibit improved oxygen barrier properties. Without limiting the present invention to a certain mechanism it is believed that the barrier properties largely are related to the fact that degradable thermoplastics are degraded through a reaction with—and thereby binding of—oxygen. It is thus assumed to be a direct relation between the degradability of the thermoplastics and its barrier properties since it consumes oxygen during its degradation. The improved oxygen barrier properties imply that an advantage in the form of materials saving is achieved in relation to a defined barrier requirement.

While for some purposes it is convenient that all layers—or the only layer—of thermoplastic material in a product are layers according to the present invention, in other connections it may be preferred that at least one layer is one that is not degradable. N the latter case it is fully possible to recycle the plastic product included layers of wholly or partially degraded thermoplastic and allow the recycled material to enter new production of thermoplastics.

### EXAMPLES

### Example 1

### Synthesis of Fat Soluble Metal Compound (Prodegradant)

a) The synthesis was conducted in an oil thermostat controlled 50 litre double mantle glass reactor having two dosing pups, e mechanically powered steel stirrer, a glass mantled thermometer, a distillation cooler, a bottom valve and a connected membrane vacuum pump. In advance a solution of 11.3 kg (41.8 moles) of ferric chloride hexahydrate in 10.5 l water and 0.11 l concentrated hydrochloric acid was prepared to produce a 21.9 kg aqueous ferric chloride solution with about 10.6% v/v iron. To provide the fat soluble organic compound 12.9 kg (45.3 moles) stearic acid was melted in the reactor by adjusting the temperature of the oil thermostat to 190° C. Then 0.18 l low aromatic white sprit (Statoil AS) and 0.35 l water were added and the pressure reduced to 200 mbar. By means of one of the dosing pumps 6.1 kg of the advance prepared ferric chloride solution was added over a 50 minutes period. By means of one of the dosing pumps 10 ml per minute of a 1% aqueous hydrogen peroxide solution was added to maintain a modest but continuous foaming in the reactor. The addition of the aqueous ferric chloride solution was adjusted so that the amount of distilled water and hydrogen chloride approximately corresponded to the amount of aqueous ferric chloride added. After completed addition of aqueous ferric chloride solution the mixture was boiled and distilled under continuous addition of 25 ml per minute 1% aqueous hydrogen peroxide solution. The amount distilled water and hydrogen chloride now were larger than the amount of 1% hydrogen peroxide solution resulting in a decreasing portion of water I the reaction mixture. When the temperature of the reaction mixture had reached 115° C. it was cooled to about 100° C. and thereafter drained through the bottom valve into 100 litre of a 1% hydrogen peroxide solution. When the resulting gas development dropped off the iron containing additive was filtered from the liquid phase. The iron containing additive then was dispersed in 1% aqueous hydrogen peroxide solution at 60-70° C. for 2 hours by means of a dispersing rod. The dispersed iron containing additive was filtered from the aqueous phase ad dried in a convection oven at 50° C. The fat soluble metal compound is referred to as FM 1.
b) In a corresponding manner to the one described above two fat soluble metal compounds (FM 2 and FM 3 with higher iron content were made.
c) The iron content of the fat soluble metal compounds from experiment a) and b) were determined by “ash conversion” at 550° C. The iron content was calculated under the condition that the combustion remains consists of Fe₂O₃. The results are shown in Table 2.

TABLE 2

| Fat soluble metal | Stearic acid added | Ferric(III)chloride | Iron content |
|---|---|---|---|
| compound | [kg] | soln. added [kg] | [%] |
| FM 1 | 12.9 | 3.42 | 1.9 |
| FM 2 | 10.9 | 4.80 | 2.9 |
| FM 3 | 12.9 | 6.10 | 3.6 |

### Example 2

### Manufacture of Combinations of Additives According to the Present Invention

To prepare the additives according to the present invention chemical substances as shown by Table 3 were used.

TABLE 3

| | Type of chemical | CAS | Referred to in |
|---|---|---|---|
| Chemical substance | substance | number | this text as |
| Prepared in 1 a) | Fat soluble metal | — | FM 1 |
| | compound | | |
| Prepared in 1 b) | Fat soluble metal | — | FM 2 |
| | compound | | |
| Prepared in 1 b) | Fat soluble metal | — | FM 3 |
| | compound | | |
| Octadecyl amine | amine | [124-30-1] | A 1 |
| Polyoxy ethylene(10)stearyl ether | polyglycolether | [9005-00-9] | E 1 |
| Polyoxy ethylene(20)stearyl ether | Polyglycol ether | [9005-00-9] | E 2 |
| Polyoxy ethylene (100)stearyl ether | Polyglycol ether | [9005-00-9] | E 3 |

In addition to the chemical substances mentioned in table 3 the following materials and qualities were used:

### Polyethylene:

LLDPE Exact 0230, ExxonMobil, hereinafter denoted PE 1
HDPE Tipelin FS 340-03, Tiszai Vegyi Kombinat Plc., Hungary, hereinafter denoted PE 2

### Polypropylene:

random copolymer R 451, Tiszai Vegyi Kombinat Plc., Hungary, hereinafter denoted PP 1
Random copolymer RE420MO, Borealis AS, Norway, hereinafter denoted PP 2
Random copolymer R 959, Tiszai Vegyi Kombinat Plc., Hungary, hereinafter denoted PP 3 homopolymer Tipplen H 605, Tiszai Vegyi Kombinat Plc., Hungary, not stabilized, suitable for production of BOPP-film (bis-oriented polypropylene film) hereinafter denoted PP 4.

### Silica:

Nyasil 20, Nyacol Nano Technologies, Inc., USA, hereinafter denoted AS.

FM 1, FM 2, FM 3, A 1, E 1, E 2, E 3 and combinations thereof were mixed with the above qualities of polyethylene (PE 1), polypropylene (PP 1 and PP 2) and/or silica (AS) in a double screw extruder (Clextral) at 190° C.-250° C. and a retention time of 60-70 seconds. The thus manufactured masterbatches had an even red-brown colour and did not show sign of degradation.

In a similar manner a masterbatch was made comprising 15% Irganox 1010 (AO 1, Ciba Specialty Chemicals, Switzerland; CAS number [6683-19-8]) and 85% LLDPE Exact 0230. In a similar manner a masterbatch was made based on 20% Irganox HP 2215 (AO 2, Ciba Specialty Chemicals, Switzerland; mixture of 57% phosphite CAS number [31570-04-4], 28% phenol CAS number [6683-19-8], 15% lactone CAS number [181314-48-7]) and 80% LLDPE Exact 0230.

Table 4a-c shows composition and denotations of the prepared masterbatches. In parenthesis behind the component denotations the portion of the component in the masterbatch is provided as % by weight. When the components are dry mixed only and not extruded, they are referred to as “dry mixed component”

TABLE 4a

| Masterbatch | Component | Component | Component | Material | Material |
|---|---|---|---|---|---|
| denotation | 1 | 2 | 3 | 1 | 2 |
| MB 1 | FM 2 (16%) | A 1 (5%) | E 1 (8%) | PP 1 (71%) | — |
| MB 2 | FM 3 (10%) | A 1 (3%) | E 2 (4%) | PP 1 (83%) | — |
| MB 3 | FM 3 (10%) | A 1 (5%) | E 2 (8%) | PE 1 (67%) | AS (10%) |
| MB 4 | AO 1 (15%) | — | — | PE 1 (85%) | — |

TABLE 4b

| Masterbatch | | |
|---|---|---|
| denotation | Dry mixed Component 1 | Dry mixed Component 2 |
| MB 5 | MB 1 (90%) | MB 4 (10%) |
| MB 6 | MB 2 (90%) | MB 4 (10%) |
| MB 7 | MB 3 (90%) | MB 4 (10%) |

TABLE 4c

| Masterbatch | Component | Component | Component | Material | Material |
|---|---|---|---|---|---|
| denotation | 1 | 2 | 3 | 1 | 2 |
| MB 11 | FM 2 (10%) | A 1 (2.5%) | E 1 (2.5%) | PP 1 (85%) | — |
| MB 12 | FM 1 (20%) | — | — | PE 1 (80%) | — |
| MB 13 | FM 2 (20%) | — | E 3 (16%) | PP 2 (67%) | — |
| MB 14 | FM 3 (10%) | — | — | PE 1 (90%) | — |
| MB 15 | AO 2 (20%) | — | — | PE 1 (80%) | — |
| MB 16 | E1 (10%) | — | — | PP 3 (90%) | |
| MB 17 | A1 (10%) | — | — | PP 3 (90%) | — |

MB 14 was stored at 25° C. before use in thermoplastics.

### Example 3

### Preparation, Accelerated Ageing and Characterization of Polypropylene Tape According to the Present Invention

a) A dry mixture of 90% v/v MB 1 and 10% v/v MB 4 was made. This dry mixture is denoted is denoted MB 5.

b) Five different PP qualities were mixed with MB 5. Additions of 1 and 2% w/w of MB 5 were prepared. The polypropylene qualities and the suppliers are shown in table 5.

TABLE 5

| PP quality | Supplier |
|---|---|
| BE 170 MO | Borealis AS, Roenningen, Norway |
| Tipplen H 681 | TVK Plc.*, Tiszaújváros, Hungary |
| Tipplen K 948 | TVK Plc.*, Tiszaújváros, Hungary |
| Tipplen K299 | TVK Plc.*, Tiszaújváros, Hungary |
| Tipplen H 649 | TVK Plc.*, Tiszaújváros, Hungary |

*Tiszai Vegyi Kombinát Plc.

c) The mixtures from b) were compounded in a double screw extruder (Clextral). In addition a P quality (Tipplen H 649) was extruded without MB 5. The extrusion conditions are shown in table 6.

TABLE 6
Extrusion conditions in the double screw extruder

| Extruder type | Double screw extruder (Clextral) | |
|---|---|---|
| Rotational frequency | 150 | [min⁻¹] |
| Charge rate | 10 | [g/min] |
| Retention time | 2-3 | [min] |

| | |
|---|---|
| Number of heat zones | 12 |
| Temperature profile | see table 7 |
| Outlet nozzle | 25 mm * 0.4 mm |

TABLE 7
Temperature profile in the double screw extruder

| Zone | 1 | 2 | 3 | 4 | 5 | 6 | 7 | 8 | 9 | 10 | 11 | 12 |
|---|---|---|---|---|---|---|---|---|---|---|---|---|
| T[° C.] | 12 | 12 | 12 | 200 | 220 | 280 | 280 | 260 | —* | 240 | 230 | 220 |

*Zone 9 is not heated

Tape samples with a thickness of about 0.4 mm were obtained and cooled in air.

d) The tape samples from c) were exposed to accelerated ageing in a UVCON weather-o-meter (Atlas Electric Devices Company, Illinois, USA) according to ISO 4892-3 (ASTM G154)—The weather-o-meter was equipped with 340 UVA fluorescent lamps. The ageing cycle comprised:
4 hours of dry illumination by 340 UVA fluorescent lamps at 60° C.
0.5 hours of water spray with deionised water at 8-10° C.
3.5 hours of condensation at 40° C.

e) To characterize degradation of the tape samples from c) the break elongation was measured according to ISO 527-2 after different ageing periods. The results are shown in table 8.

TABLE 8

| | | Accelerated | Accelerated | Accelerated |
|---|---|---|---|---|
| | MB 5 | ageing | ageing | ageing |
| PP quality | content | 0 hours | 24 hours | 48 hours |
| BE 170 MO | 2% w/w | 12 ± 3 | <5 | <2 |
| Tipplen H 681 | 2% w/w | 617 ± 163 | 5 ± 3 | 6 ± 4 |
| Tipplen K 948 | 2% w/w | 27 ± 10 | <5 | <2 |
| Tipplen K299 | 2% w/w | 7 ± 3 | <5 | <2 |
| Tipplen H 649 | 1% w/w | 711 ± 94 | 17 ± 8 | <5 |
| Tipplen H 649 | 0% w/w | 702 ± 33 | 706 ± 54 | 650 ± 44 |

It was discovered that the break elongation for all tape samples containing MB 5 was drastically reduced after short periods of accelerated ageing. This indicated an efficient degradation progress.

f) After 30 hours of accelerated ageing the molecular weights of the degraded tape samples were determined by SEC analysis. SEC (Size Exclusion Chromatography) is also called GPC (Gel Permeation Chromatography). The SEC analysis conditions are shown in table 9.

TABLE 9
SEC analysis conditions

| | |
|---|---|
| Instrument type | PL-GPC 210 |
| Column type | 4*PL gel 20 micron LS |
| Solvent | 1,2,4-trichloro benzene |
| Temperature | 145° C. |
| Injection volume | 0.20 ml |
| Test concentration | 2-3 mg/ml |
| Calibration | Polystyrene standards |
| Mark Houwink constants | K = 14.1*10⁻⁴ dL/g, a = 0.7 |

The results of the SEC-analysis are shown in table 10.

TABLE 10
Average molecular weight M_{w} and Mₙ and polydispersity
PD after 830 hours of accelerated ageing

| | | | | Polymer |
|---|---|---|---|---|
| PP quality | MB 5 content | Mₙ | M_{w} | dispersity |
| BE 170 MO | 2% w/w | 919 ± 10 | 2518 ± 30 | 2.7 ± 0.06 |
| Tipplen H 681 | 2% w/w | 695 ± 12 | 1554 ± 41 | 2.2 ± 0.02 |
| Tipplen K 948 | 2% w/w | 807 ± 16 | 1864 ± 44 | 2.3 ± 0.01 |
| Tipplen K299 | 2% w/w | 767 ± 0 | 1752 ± 8 | 2.3 ± 0.01 |
| Tipplen H 649 | 1% w/w | 707 ± 24 | 1572 ± 50 | 2.2 ± 0.00 |

The SEC analysis clearly shows that all PP tape samples are completely degraded after 830 hours of accelerated ageing. The average molecular weight M_{w} of the tape samples were drastically reduced from about 80 000-120 000 to 1 500-2 500. The molecular weight is thus sufficiently low to allow digestion by micro organisms. This is an important property of a degradable polymer.

### Example 4

### Preparation of 5 Layer Barrier Film According to the Invention

a) A dry mixture of 90% v/v MB 2 and 10% v/v MB 4 was made. This dry mixture was denoted 6.

b) A 5 layer barrier film was made by means of a 5 layer foil blowing process. The five layers barrier film comprised PE, modified PE (adhesive layer), ethylene vinyl alcohol copolymer (EVOH, 38 mol-% ethylene, Soarnol ET 3802, Nippon Gohsei, Japan), modified PE (adhesive layer), PE. 1% v/v and 2% v/v MB 6 were used. Same amount MB 6 was used in all 5 layers. The EVOH layer thickness was 5 μm or 10 μm. The overall thickness was 60 μm. The process temperature was 190 to 230° C.

c) The oxygen transmission rate (OTR) was measured with a standardized measuring method using an Oxtran instrument. The results are shown in table 11. OTR of Soarnol ET 3802 without MB 6 was provided from the supplier's product information.

TABLE 11

| | Thickness | | |
|---|---|---|---|
| No. | EVOH layer | MB 6 | OTR [cm³O₂/m²*day] |
| 1 | 10 μm | 1% | 0.90 ± 0.10 |
| 2 | 5 μm | 1% | 2.12 ± 0.03 |
| 3 | 5 μm | 2% | 1.51 ± 0.03 |
| 4 | 10 μm | 0% | 3 ± 0.5* |
| 5 | 5 μm | 0% | 5 ± 1.0* |

*Information from product data sheet (Nippon Gohsei)

It is clearly shown that addition of MB 6 reduced OTR of the EVOH based 5 layer barrier film significantly.

FIG. 1 is an AFM picture (atomic force microscopy) of a section straight through the EVOH based 5 layer barrier film and shows 1) PE, 2) modified PE (adhesive layer), 3) EVOH, 4) modified PE (adhesive layer) and 5) PE.

### Example 5

### Preparation of PE Shopping Bags According to the Present Invention

a) A dry mixture of 90% v/v MB 3 and 10% v/v was made. This dry mixture is denoted

b) Shopping bags based on high density polyethylene (HDPE) were made with 2% v/v and 3% v/v addition of MB 7. The bags had a thickness of 16 μm.

c) The shopping bags were exposed to accelerated ageing as described in Example 3d. After 240 hours of accelerated ageing the bags had become very brittle and became powder when lightly kneaded between fingers. Control bags not containing M 7 did not show any visible signs of degradation.

### Example 6

### Addition of 5 Layer Barrier Material in Polypropylene

In industrial preparation of 5 layer barrier (laminates) there are commonly significant amounts of laminate “cut-off”. It is desirable to be able to add “cut-off” in the first (outer) layer of another laminate product. The amount of cut-off that can successfully be added in this manner is limited due to formation of gel particles. Gel particles make the production of new laminate products difficult and reduce the quality of the new laminate product.

To determine if additives according to the present invention can increase the amount of cut-off that successfully can be included in a new laminate product, 20% cut-off from a laminate was extruded along with 2% MB 5 into a PP quality (RB 307, Borealis AS). The extrusion conditions were as in Example 3 with the difference that the maximum temperature in the extruder was 240° C. The cut-off comprises 5 layers: P, modified PP (adhesive layer), ethylene vinyl alcohol copolymer (EVOH), modified PP (adhesive layer), PP. The gel particles in the resulting PP tape were quantified with light microscopy. For comparison a corresponding PP tape without MB 5 was extruded. The results are shown in table 12.

TABLE 12

| | | | | Maximum | |
|---|---|---|---|---|---|
| | PP | Cut-off | MB 5 | prosess | Gel particles |
| No. | [%] | [%] | [%] | temperature | [%] |
| 1 | 80 | 20 | 0 | 240° C. | 6.8 ± 1.6 |
| 2 | 78 | 20 | 2 | 240° C. | 0.8 ± 0.1 |

It is demonstrated that addition of MB 5 reduces the amount of gel particles and thus that the amount of cut-off in a new laminate product can be increased.

### Example 7

### Preparation, Thermal Ageing and Mechanical Testing of Thermoplastic Tensile Strength Samples According to the Present Invention

Masterbatches and thermoplastic resins from Example 2 were dry mixed as indicated in table 13. The relative amounts are stated as % by weight.

TABLE 13

| | Dry mixed | Dry mixed | Dry mixed | Dry mixed |
|---|---|---|---|---|
| Combi- | Component | Component | Component | Component |
| nation | 1 | 2 | 3 | 4 |
| K 1 | MB 14 (2%) | — | — | PP 2 (98%) |
| K 2 | MB 14 (5%) | — | — | PP 2 (95%) |
| K 4 | MB 14 (2%) | MB 17 (10%) | — | PP 2 (88%) |
| K 5 | MB 14 (2%) | MB 16 (10%) | MB 17 (10%) | PP 2 (78%) |
| K 6 | MB 14 (5%) | MB 16 (10%) | MB 17 (10%) | PP 2 (75%) |
| K 7 | MB 11 (2%) | — | — | PP 2 (98%) |
| K 8 | MB 12 (2%) | — | — | PP 2 (98%) |
| K 9 | MB 12 (2%) | — | — | PE 2 (98%) |
| K 10 | MB 13 (2%) | — | — | PP 2 (98%) |
| K 12 | MB 12 (2%) | MB 17 (10%) | — | PE 2 (88%) |
| K 13 | MB 12 (2%) | MB 16 (10%) | MB 17 (10%) | PE 2 (78%) |
| K 14 | MB 13 (5%) | — | — | PP 4 (95%) |
| K 15 | MB 13 (5%) | — | MB 17 (10%) | PP 4 (85%) |

K1, K2, K8 and K9 are reference samples and comprises a metal compound but neither compound ii) nor compound iii) as described in the claims. With the exception of K 14 the other combinations comprise compound iii) in addition to a metal compound or a combination of compound ii) and compound iii) in addition to a metal compound. K 14 comprises compound ii) in addition to a metal compound and could be compared to K 15 which comprises compound iii) in addition.

The combinations in table 13 were extruded at temperatures up to 250° C. in a manner corresponding to Example 3. The extruded combinations thereafter were injection moulded to 2 mm thick plates by means of a Battenfield injection moulding machine and a temperature gradient from 200° C.-230° C. The injection moulded plates thereafter were hot pressed (rolled) at 230° C. to plates of 0.1 mm thickness.

Thermoplastic tensile strength samples suitable for mechanical testing were punched fro the hot pressed plates by means of a sample puncher (Zwick & Co. KG, Einsingen/Ulm, Germany). The sapless had the shape of “dog bones” of the following dimensions:

| | |
|---|---|
| Total length | 67 mm |
| Width at the sample end | 14 mm |
| Width in the tensile zone | 5 mm |

The tensile test samples were thermally aged in a convection oven at 80° C. for 0, 5 and 10 days.

The mechanical properties break elongation [%] and maximum tension [MPa] of the tensile test samples were measured by means of tensile tests based in ISO 527-2. The results are shown in table 14 and 15 and are mean values of at least five tests each. In the cases where the samples were too brittle to allow measurement of elongation and maximum tension, they are labelled “sample too brittle”.

TABLE 14
break elongation of thermoplastic tensile test samples

| | break elongation | break elongation | break elongation |
|---|---|---|---|
| | after 0 days at | after 5 days at | after 10 days at |
| Combination | 80° C. [%] | 80° C. [%] | 80° C. [%] |
| K 1 | 652 ± 113 | 210 ± 165 | 8 ± 5 |
| K 2 | 536 ± 261 | 426 ± 367 | 13 ± 13 |
| K 4 | 868 ± 84 | 270 ± 286 | Sample too brittle |
| K 5 | 947 ± 62 | 4 ± 4 | Sample too brittle |
| K 6 | 905 ± 112 | 4 ± 3 | Sample too brittle |
| K 7 | 682 ± 357 | 585 ± 284 | 5 ± 2 |
| K 8 | 669 ± 242 | 720 ± 155 | 569 ± 291 |
| K 9 | 614 ± 311 | 355 ± 361 | 610 ± 331 |
| K 12 | 797 ± 103 | 765 ± 166 | 11 ± 10 |
| K 13 | 675 ± 79 | 43 ± 13 | 2 ± 1 |
| K 14 | 793 ± 383 | 10 ± 4 | Sample too brittle |
| K 15 | 787 ± 190 | 6 ± 4 | Sample too brittle |

TABLE 15
maximum tensile strength of thermoplastic test samples

| | Maximum tension | Maximum tension | Maximum tension |
|---|---|---|---|
| | after 0 days at | after 5 days at | after 10 days at |
| Combination | 80° C. [MPa] | 80° C. [MPa] | 80° C. [MPa] |
| K 1 | 27.1 ± 2.1 | 29.7 ± 0.7 | 22.2 ± 2.0 |
| K 2 | 27.0 ± 1.2 | 27.3 ± 2.7 | 21.7 ± 5.1 |
| K 4 | 33.5 ± 2.4 | 28.7 ± 2.6 | Sample too brittle |
| K 5 | 37.7 ± 3.0 | 17.2 ± 7.6 | Sample too brittle |
| K 6 | 34.4 ± 3.9 | 17.1 ± 5.5 | Sample too brittle |
| K 7 | 33.1 ± 5.5 | 29.5 ± 1.1 | 21.1 ± 3.1 |
| K 8 | 30.3 ± 1.6 | 32.7 ± 3.1 | 28.5 ± 1.5 |
| K 9 | 28.7 ± 3.6 | 30.1 ± 2.5 | 28.4 ± 1.3 |
| K 12 | 29.7 ± 6.9 | 27.9 ± 7.7 | 12.7 ± 3.0 |
| K 13 | 20.7 ± 2.8 | 16.5 ± 0.6 | 8.9 ± 2.3 |
| K 14 | 43.5 ± 5.6 | 30.6 ± 5.5 | Sample too brittle |
| K 15 | 36.7 ± 6.8 | 23.9 ± 7.2 | Sample too brittle |

Tensile test samples comprising compound ii) in addition to a certain metal compound or a combination of compound ii) and compound iii) in addition to a certain metal compound are more brittle or exhibit shorter break elongation than do tensile test samples comprising a certain metal compound but neither compound ii) nor compound iii).

It is clearly demonstrated that by means of a combination of additives according to the present invention polyolefins can be prepared with a very short lifetime at temperatures around 80° C.

The examples demonstrate that the present invention is well suited for obtaining the above mentioned objects. Thus, the combination of the metal comprising compound and a compound chosen among not sterically hindered, aliphatic amines, oligoamines or polyamines, or a precursor for not sterically hindered, aliphatic amines, oligoamines or polyamines, properties and advantages in particular with respect to improved oxygen barrier, which can not be derived from any previously known technology in the field.

1. Combination of additives useful in the manufacture of thermoplastics, the combination comprising at least
i) one metal comprising compound, characterized in that it also comprises at least
ii) one compound chosen among not sterically hindered, aliphatic amines, oligoamines or polyamines, or a precursor for not sterically hindered, aliphatic amines, oligoamines or polyamines.

2. Combination as claimed in claim 1, characterized in that the metal in the metal comprising compound is chosen among Sc, Ti, V, Cr, Mn, Fe, Co, Ni, Cu, Ce.

3. Combination as claimed in claim 1, characterized in that the metal in the metal comprising compound is chosen among Fe, Co, Cu, Ce, V.

4. Combination as claimed in claim 1, characterized in that the metal comprising compound is a fat soluble metal compound.

5. Combination as claimed in claim 1, characterized in that the metal comprising compound is a salt.

6. Combination as claimed in claim 1, characterized in that the metal comprising compound is a metal complex.

7. Combination as claimed in claim 1, characterized in that the metal comprising compound is added to the thermoplastic during the manufacture or preparation process in the form of metal compounds such as catalyst remains, abrasion “products” from preparation equipment and contaminations.

8. Combination as claimed in claim 1, characterized in that said amine, oligoamine or polyamine wholly or partially can be described as: 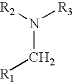
where the group R₁, R₂, R₃ are chosen among hydrogen, hydroxyl, non substituted saturated or unsaturated C₁-C₂₄ alkyl, substituted saturated or unsaturated C₁-C₂₄ alkyl, substituted or non substituted aryl, aliphatic or aromatic carbonyl, the chains of said compounds optionally containing one or more of the elements oxygen, nitrogen, sulphur, phosphorous, silicon, and boron; or groups chosen among condensation products or addition products of one or more typical chemical compounds such as acids, alcohols, phenols, amines, aldehydes, or epoxides.

9. Combination as claimed in claim 1, characterized in that the amine wholly or partially can be described as:
X—(O—CR₁R₂—CR₃R₄—O)ₚ—(CR₁R₂—CR₃R₄—O—CR₅R₆—CR₇R₈—O)_{q}—(CR₅R₆—CR₇R₈—O)ᵣ—Y
where the group R₁-R₈ are chosen among hydrogen, hydroxyl, non substituted saturated or unsaturated C₁-C₂₄ alkyl, substituted saturated or unsaturated C₁-C₂₄ alkyl, substituted or non substituted aryl, aliphatic or aromatic carbonyl, the chains of said compounds optionally containing one or more of the elements oxygen, nitrogen, sulphur, phosphorous, silicon, and boron while at least one of X, Y are chosen among amino, alkylamino, dialkylamino while the other of X, Y is chosen among hydrogen, hydroxyl, amino, alkylamino, dialkylamino, while p, q, r being integers from 0 to about 1000, provided that at least one of p, q, r is larger than 0.

10. Combination as claimed in claim 1, characterized in that the compound ii) wholly or partially is present as a salt.

11. Combination as claimed in claim 1, characterized in that the compound ii) wholly or partially is present as a metal-amine complex.

12. Combination as claimed in claim 1, characterized in that the compound ii) is present as a precursor for not sterically hindered, aliphatic amine, oligoamine, or polyamine and that amine, oligoamine, or polyamine is formed in situ at or subsequent to combination with compound i).

13. Combination as claimed in claim 1, characterized in that the amount ratios between metal in compound i) and the entire compound ii) is in the range 1:30 to 1:3.

14. Combination as claimed in claim 1, characterized in that the combination further comprises a compound iii) chosen among compounds which wholly or partially can be manufactured by condensation of one or more alcohols and compounds which can be manufactured by ring-opening addition of heterocyclic organic compounds comprising at least one oxygen atom.

15. Combination as claimed in claim 14, characterized in that the compound iii) is a condensation product of mono or polyfunctional alcohols

16. Combination as claimed in claim 14, characterized in that compound iii) contains at least one oxygen containing cyclo-aliphatic structure element

17. Combination as claimed in claim 14, characterized in that the compound iii) which wholly or partially can be manufactured by ring opening addition of heterocyclic organic compounds that contain at least one oxygen atom, is an epoxide derivative.

18. Combination as claimed in claim 14 characterized in that the compound iii) which wholly or partially can be manufactured by ring opening addition of heterocyclic organic compounds that contain at least one oxygen atom, is an oxetane derivative.

19. Combination as claimed in claim 14, characterized in that the compound iii) which wholly or partially can be manufactured by ring opening addition of heterocyclic organic compounds that contain at least one oxygen atom, is a furan derivative.

20. Combination as claimed in claim 14, characterized in that the compound iii) can be described by:
X—(O—CR₁R₂—CR₃R₄—O)ₖ—(CR₁R₂—CR₃R₄—O—CR₅R₆—CR₇R₈—O)ₗ—(CR₅R₆—CR₇R₈—O)ₘ—Y
where the groups R₁-R₈ are chosen among hydrogen, hydroxyl, non substituted saturated or unsaturated C₁-C₂₄ alkyl, substituted saturated or unsaturated C₁-C₂₄ alkyl, substituted or non substituted aryl, aliphatic or aromatic carbonyl, the carbon chains of said compounds optionally comprising one or more of the elements oxygen, nitrogen, sulphur, phosphorus, silicon, and boron and X, Y being chosen among hydrogen, acyl, non substituted saturated or unsaturated C₁-C₂₄ alkyl, substituted saturated or unsaturated C₁-C₂₄ alkyl, substituted or non substituted aryl, aliphatic or aromatic carbonyl, the carbon chains of said compounds optionally containing one or more of the elements oxygen, nitrogen, sulphur, phosphorous, silicon, and boron, k, l and m being integers from 0 to about 1000, provided that at least one of k, l, m is larger than 0.

21. Combination as claimed in claim 1, characterized in that at least one alcohol component of the compound ii) can be described by:
X—(CR₁R₂—)ₙ(CR₃R₄—)ₒOH
the groups R₁-R₄ being chosen among hydrogen, hydroxyl, non substituted saturated or unsaturated C₁-C₂₄ alkyl, substituted saturated or unsaturated C₁-C₂₄ alkyl, substituted or non substituted aryl, aliphatic or aromatic carbonyl, the carbon chains of said compounds optionally containing one or more of the elements oxygen, nitrogen, sulphur, phosphorous, silicon, and boron, X being chosen among hydrogen, hydroxyl, acyl, non substituted saturated or unsaturated C₁-C₂₄ alkyl, substituted saturated or unsaturated C₁-C₂₄ alkyl, substituted or non substituted aryl, aliphatic or aromatic carbonyl, the carbon chains of said compounds optionally containing one or more of the elements oxygen, nitrogen, sulphur, phosphorous, silicon, and boron while n, 0 being integers from 0 to about 30, provided that at least one of n, 0 is larger than 0.

22. Combination as claimed in claim 14, characterized in that at least one alcohol component of compound iii) is a monofunctional alcohol.

23. Combination as claimed in claim 14, characterized in that at least one alcohol component of compound iii) is a polyfunctional alcohol.

24. Combination as claimed in claim 1, characterized in that the combination is in the form of a masterbatch.

25. Combination as claimed in claim 24, characterized in that the masterbatch comprises further additives in the form of process stabilizers, long term stabilizers, pigments, dyes, slip agents, nucleation agents, and/or fillers.

26. Combination as claimed in claim 24, characterized in that the masterbatch is in the form of a dry mixture.

27. Combination as claimed in claim 26, characterized in that the dry mixture additionally comprises at least 30% by weight of a stabilizer masterbatch.

28. Combination as claimed in claim 27, characterized in that the stabilizer masterbatch comprises at least one component chosen among phosphite, phenol, lactone, hydroxylamine, and alfa-tocoferol.

29. Combination as claimed in claim 1, characterized in that it further comprises at least one thermoplastic resin in an amount of at least 50% by weight chosen among polyethylene LD, Polyethylene HD, polyethylene LLD, polypropylene homo polymer, polypropylene random copolymer, polypropylene block copolymer, polybutylene, EVOH, polyamide, polyvinyl alcohol, polyester, polyurethane, and polystyrene as well as any combination of two or more thereof.

30. Combination as claimed in claim 1, characterized in that it also comprises a thermoplastic resin in an amount of at least 95% by weight chosen among polyethylene LD, Polyethylene HD, polyethylene LLD, polypropylene homo polymer, polypropylene random copolymer, polypropylene block copolymer, polybutylene, EVOH, polyamide, polyvinyl alcohol, polyester, polyurethane, and polystyrene as well as any combination of two or more thereof.

31. Combination as claimed in claim 1, characterized in that it further comprises at least one thermoplastic resin in an amount of at least 99% by weight chosen among polyethylene LD, Polyethylene HD, polyethylene LLD, polypropylene homo polymer, polypropylene random copolymer, polypropylene block copolymer, polybutylene, EVOH, polyamide, polyvinyl alcohol, polyester, polyurethane, and polystyrene as well as any combination of two or more thereof.

32. Combination as claimed in claim 1, characterized in that it further comprises at least two thermoplastic resins in an amount of at least 95% by weight the two thermoplastics constituting a laminate of at least two layers in which compound i) and compound ii) independent of each other may be present in one or more layers.

33. Combination as claimed in claim 30, characterized in that it further comprises a nucleation agent.

34. Combination as claimed in claim 33, characterized in that the nucleation agent can be prepared by use of sorbitol.

35. Combination as claimed in claim 33, characterized in that the nucleation agent can be manufactured by use of a compound chosen among benzaldehyde, aceto-phenone, or benzoic acid.

36. Method for changing properties of thermoplastics, characterized in that the thermoplastics, during any stage of their production, there are added at least
i) a metal comprising compound, and
ii) a compound chosen among a not sterically hindered, aliphatic amine, oligoamine or polyamine, or a precursor for a not sterically hindered, aliphatic amine, oligoamine or polyamine.

37. Thermoplastic material comprising a metal comprising compound i) one metal comprising compound, characterized in further comprising at least one compound ii) chosen among a not sterically hindered, aliphatic amine, oligoamine or polyamine, or a precursor for a not sterically hindered, aliphatic amine, oligoamine or polyamine.

38. Thermoplastic material as claimed in claim 37, characterized in that it further comprises a compound iii) chosen among compounds which wholly or partially can be manufactured by condensation of one or more alcohols and compounds which can be manufactured by ring-opening addition of heterocyclic organic compounds comprising at least one oxygen atom.

39. Thermoplastic material as claimed in claim 37, characterized in that it has a permeability for oxygen which is lower than the permeability of a corresponding thermoplastic material which does not include the combination of said compounds i) and ii).

40. Thermoplastic material as claimed in claim 39, characterized in that the permeability for oxygen is reduced with at least 50% compared to a corresponding thermoplastic material which does not include the combination of said compounds i) and ii).

41. Thermoplastic material as claimed in claim 37, characterized in that it comprises at least two thermoplastic resins in an amount of at least 95% by weight, the thermoplastic material being constituted by a laminate of at least two layers while compound i) and compound ii) independent of each other may be present in one or more layers.

42. Product of thermoplastic material as claimed in claim 37, characterized in that it is prepared by means of film blowing or foil extrusion with a film or a foil as end product or intermediate product, hereunder bis-oriented film.

43. Product as claimed in claim 42, characterized in that it is chosen among plastic bags, sunlight collector foils, other types of foils for use in agriculture, foodstuff packaging, other packaging, and other types of bags and sacks.

44. Product of thermoplastic material as claimed in claim 37, characterized in that it is prepared by means of injection moulding to an injection moulded end or intermediate product.

45. Product as claimed in claim 44, characterized in that it is chosen among foodstuff packaging other packaging, disposable articles for household or industry or for use with foodstuff and/or beverage.

46. Product of thermoplastic material as claimed in claim 37, characterized in that it is prepared by means of thermoforming to a thermoformed end or intermediate product.

47. Product as claimed in claim 46, characterized in that it is chosen among foodstuff packaging, other packaging, disposable articles for household or industry or for use with foodstuff and/or beverage.

48. Product of thermoplastic material as claimed in claim 37, characterized in that it is prepared by means of extrusion to an extruded end or intermediate product.

49. Product as claimed in claim 48, characterized in that it is chosen among products for industrial purposes, constructional purposes, hereunder transportation and building constructions, fibre shaped products, band shaped products, hereunder woven and non-woven products.

50. Product of thermoplastic material as claimed in claim 37, characterized in that it is prepared by means of blow moulding, to a blow moulded end or intermediate product.

51. Product as claimed in claim 50, characterized in that it is chosen among foodstuff packaging, other packaging, disposable articles for household or industry or for use with foodstuff and/or beverage.

52. Product of thermoplastic material as claimed in claim 37, characterized in that it is prepared by means of co-extrusion of at least two layers to a laminated end or intermediate product.

53. Product as claimed in claim 52, characterized in that it is chosen among barrier films or barrier receptacles for nutrients or chemicals which are sensitive to air.
